(19) United States
(12) Patent Application Publication
(10) Pub. No.: US 2009/0313556 A1
(43) Pub. Date: Dec. 17, 2009

(54) REDISTRIBUTION OF LICENSED ITEMS IN A VIRTUAL UNIVERSE

(76) Inventors: Rick A. Hamilton, II, Charlottesville, VA (US); Brain M. O'Connell, Cary, NC (US); Clifford A. Pickover, Yorktown Heights, NY (US); Keith R. Walker, Austin, TX (US)

Correspondence Address: HOFFMAN WARNICK LLC, 75 STATE ST, 14TH FLOOR, ALBANY, NY, 12207, US

(21) Appl. No.: 12/139,310

(22) Filed: Jun. 13, 2008

(51) Int. Cl. G06F 3/038

(52) U.S. Cl. 715/757

(57) ABSTRACT

An approach that redistributes licensed items in a virtual universe is described. In one embodiment, there is a marketplace facilitation tool for use in a virtual universe. A database is configured to store information relating to the virtual universe. A receiving component is configured to receive a request for an item within the virtual universe. An inventory search component is configured to search the database for other avatars within the virtual universe that may possess the requested item. A transfer component is configured to establish a transfer of the item between at least one avatar determined to have possession of the requested item and an avatar requesting the item after there has been a manifestation of an assent to transfer the item. An intellectual property enforcement component is configured to specify and enforce any intellectual property rights restrictions with the item to the transfer component for the transfer to the avatar requesting the item.

### FIELD OF THE INVENTION

This invention relates generally to virtual universes, and more specifically to redistribution of licensed items within a virtual universe.

### BACKGROUND OF THE INVENTION

Virtual universes or virtual worlds are computer-based simulated environments intended for its users to inhabit and interact via avatars, which are personas or representations of the users of the virtual universes and generally take the form of two-dimensional or three-dimensional human or fantastical representations of a person's self. These types of virtual universes are now most common in massive multiplayer online games, such as Second Life which is a trademark of Linden Research in the United States (US), other countries or both.

Avatars in these types of virtual universes, which can number well over a million, have a wide range of business and social experiences. These avatars create, manipulate and buy and sell many aspects of their virtual lives. As a result, these virtual universes provide a fertile ground for exchanging items created for use by the avatars that exist in these virtual universes. An illustrative listing of some items that are created and exchanged in a virtual universe include apparel for avatars, animations for a multitude of purposes (e.g., instructional material), avatar accessories (e.g., jewelry, hairpieces, etc.), scripts for performing certain functions in the virtual universes, building components, avatar appearance features, recreation and equipment (e.g., dancing poles), automobiles, etc. In some virtual universes it is common that users retain the intellectual property rights in the digital content that they create and exchange in the universe. Current approaches of exchanging items within these virtual universes do not provide any functionality that enables users to monitor and enforce the intellectual property rights in the digital content of the items that they create and exchange with others. If terms of the transfer are not being complied with, then the user that created the digital content in the items may be harmed monetarily and/or artistically (e.g., lack of attribution to the item).

### SUMMARY OF THE INVENTION

In a first embodiment, there is a method for facilitating an exchange of items in a virtual universe. In this embodiment, the method comprises: receiving a request for an item within the virtual universe; establishing a transfer of the item between at least one provider and an avatar requesting the item after there has been a manifestation of an assent to transfer the item; and specifying any intellectual property rights restrictions with the item in the transfer between the at least one provider and the avatar requesting the item.

In a second embodiment, there is a method for facilitating a marketplace to exchange items in a virtual universe. In this embodiment, the method comprises: receiving a request for an item within the virtual universe; matching at least one provider of that item with an avatar requesting the item; establishing a transfer of the item between the at least one provider and the avatar requesting the item after there has been a manifestation of an assent to transfer the item; and specifying any intellectual property rights restrictions with the item in the transfer between the at least one provider and the avatar requesting the item.

In a third embodiment, there is a computer system for facilitating a marketplace to exchange items in a virtual universe. In this embodiment, there is at least one processing unit and memory operably associated with the at least one processing unit. A marketplace facilitation tool is storable in memory and executable by the at least one processing unit. The tool comprises a database configured to store a plurality of information relating to the virtual universe. A receiving component is configured to receive a request for an item within the virtual universe. An inventory search component is configured to search the database for other avatars within the virtual universe that may possess the requested item. A transfer component is configured to establish a transfer of the item between at least one avatar determined to have possession of the requested item and an avatar requesting the item after there has been a manifestation of an assent to transfer the item. An intellectual property enforcement component is configured to specify and enforce any intellectual property rights restrictions with the item to the transfer component for the transfer to the avatar requesting the item.

In a fourth embodiment, there is a computer-readable medium storing computer instructions, which when executed, enables a computer system to facilitate a marketplace to exchange items in a virtual universe. In this embodiment, the computer instructions comprise receiving a request for an item within the virtual universe; matching at least one provider of that item with an avatar requesting the item; establishing a transfer of the item between the at least one provider and the avatar requesting the item after there has been a manifestation of an assent to transfer the item; and specifying any intellectual property rights restrictions with the item in the transfer between the at least one provider and the avatar requesting the item.

In a fifth embodiment, there is a method for deploying a marketplace facilitation tool for use in a computer system that facilitates a marketplace to exchange items in a virtual universe. In this embodiment, a computer infrastructure is provided and is operable to receive a request for an item from an avatar within the virtual universe; establish a transfer of the item between at least one provider and the avatar requesting the item after there has been a manifestation of an assent to transfer the item; and specify any intellectual property rights restrictions with the item in the transfer between the at least one provider and the avatar requesting the item.

### BRIEF DESCRIPTION OF THE DRAWINGS

FIG. 1 shows a high-level schematic diagram showing a networking environment for providing a virtual universe according to one embodiment of this invention;

FIG. 2 shows a more detailed view of a virtual region shown in the virtual universe of FIG. 1;

FIG. 3 shows a more detailed view of the virtual universe client shown in FIG. 1;

FIG. 4 shows a more detailed view of some of the functionalities provided by the server array shown in FIG. 1;

FIG. 5 shows a marketplace facilitation tool according to one embodiment of this invention that operates in the environment shown in FIG. 1;

FIG. 6 shows a more detailed view of an intellectual property enforcement component that operates in the marketplace facilitation tool shown in FIG. 5;

FIG. 7 shows a flow chart describing the operation of the marketplace facilitation tool shown in FIG. 5 according to one embodiment;

FIG. 8 shows a flow chart describing the operation of monitoring usage of an exchanged item for conformance with intellectual property rights restrictions specified to the item according to one embodiment; and

FIG. 9 shows a schematic of an exemplary computing environment in which elements of FIGS. 1-8 may operate.

### DETAILED DESCRIPTION OF THE INVENTION

Embodiments of this invention are directed to a technique for facilitating an exchange of items in a virtual universe. The exchange of items can arise in scenarios where an avatar in a virtual universe sees an item in the virtual universe (whether owned by another avatar or offered for sale by a third party such as a store) that has intellectual property restrictions associated therewith. In one embodiment, the avatar can make an offer for this item and a transfer of the item is established after there has been a manifestation of an assent to transfer the item between parties. Upon transferring the item, intellectual property restrictions are specified and imposed on the avatar receiving the item. In another embodiment, the exchange of items arises in the form of a marketplace (i.e., bartering, auctioning, trading, or selling). The marketplace features of this invention provide the capability to match buyers desiring specific items with sellers that are in possession of these items. In addition to facilitating an exchange of items between buyers and sellers of virtual universe, embodiments of this invention provide functionality for enforcing licensing and intellectual property rights associated with the exchanged items. This includes specifying intellectual property rights restrictions with the exchanged items and monitoring usage of the items for conformance with any specified restrictions.

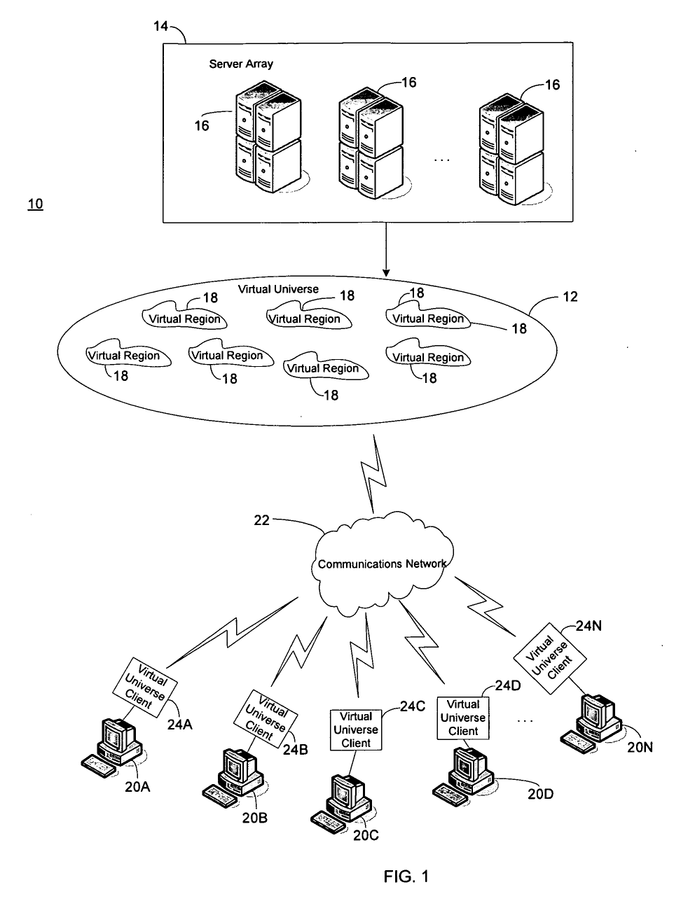

FIG. 1 shows a high-level schematic diagram showing a networking environment 10 for providing a virtual universe 12 according to one embodiment of this invention in which a service for providing a marketplace to exchange items and monitor intellectual property restrictions associated with the items can be utilized. As shown in FIG. 1, the networking environment 10 comprises a server array or grid 14 comprising a plurality of servers 16 each responsible for managing a portion of virtual real estate within the virtual universe 12. A virtual universe provided by a typical massive multiplayer online game can employ thousands of servers to manage all of the virtual real estate. The content of the virtual real estate that is managed by each of the servers 16 within the server array 14 shows up in the virtual universe 12 as a virtual region 18.

Like the real-world, each virtual region 18 within the virtual universe 12 comprises a living landscape having things such as buildings, stores, clubs, sporting arenas, parks, beaches, cities and towns all created by residents of the universe that are represented by avatars. These examples of items are only illustrative of some things that may be found in a virtual region and are not limiting. Furthermore, the number of virtual regions 18 shown in FIG. 1 is only for illustration purposes and those skilled in the art will recognize that there may be many more regions found in a typical virtual universe, or even only one region in a small virtual universe. FIG. 1 also shows that users operating computers 20A-20N (hereinafter referred generally as 20) interact with the virtual universe 12 through a communication network 22 via virtual universe clients 24A-24N (hereinafter referred generally as 24) that resides in the computers, respectively.

One of the ways that users of the virtual universe 12 can use the virtual universe client 24 to interact with the universe is to create digital content or items for the virtual universe. An illustrative but non-limiting listing of items that can be created through the virtual universe client 24 includes items such as apparel for avatars, animations for a multitude of purposes (instructional material), avatar accessories (e.g., jewelry, hairpieces, clothing, etc.), scripts for performing certain functions in the virtual universes, building components, avatar appearance features, recreation and equipment (e.g., bicycles), automobiles, etc.

As mentioned above, embodiments of this invention are directed to facilitating the exchange of these types of items between avatars that reside in the virtual universe 12 and providing a mechanism to enforce the intellectual property rights restrictions associated with the exchanged items. For example, if an avatar purchases or exchanges an item that includes executable code, the avatar obtains not only the executable code or item itself but a license to use it under specified conditions. These restrictions are usually defined in the items of an End User License Agreement. Those skilled in the art will recognize that licenses may vary from item to item and from one selling avatar to another selling avatar. For example, the license for avatar clothing or an avatar design tool may require that only a single resident have one copy of the item at a time in their inventory, while a license for a gesture or hairpiece may allow a resident to install and use it on several avatars.

In another example, an individual avatar or a set of individual avatars (such as employees in a corporation) may desire to upgrade a virtual universe item (e.g., software product, enabling tool, or an old-looking design of an object) from one version to a newer version (e.g., upgrade from an avatar-experimenter toolkit 3.0 version to a 4.0 version). More specifically, an avatar may have an old version of a device that has limited functions and has a desire for the newer version that has enhanced functionality. Not only does the marketplace of this invention provide a mechanism to exchange this type of item through bartering, auctioning, trading, or selling, it can match avatars wishing to exchange or give up such items or software versions with those avatars who wish to have the item or software version. Using the above example, someone else in the avatar's corporation may be quite happy working with avatar-experimenter toolkit 3.0 even if another avatar desires the newer avatar experimenter toolkit 4.0.

Below are additional details on the marketplace facilitation tool of this invention and how it enables avatars to exchange items in the virtual universe 12 and enforce the intellectual property restrictions associated with the exchanged items.

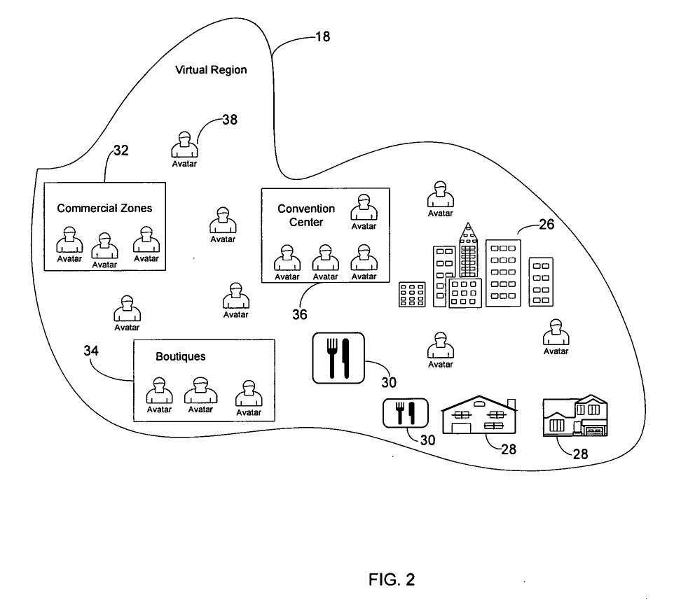

FIG. 2 shows a more detailed view of what one virtual region 18 shown in the virtual universe 12 of FIG. 1 may comprise. As an example, the virtual region 18 shown in FIG. 2 comprises a downtown office center 26, homes 28, restaurants 30, commercial zones 32 and boutiques 34 for shopping and a convention center 36 for meetings and various conventions. Residents or avatars 38, which as mentioned above, are personas or representations of the users of the virtual universe, roam all about the virtual region by walking, driving, flying or even by teleportation or transportation which is essentially moving through space from one point to another, more or less instantaneously. These examples of items in the virtual region 18 shown in FIG. 2 are only illustrative of some things that may be found in a virtual region and those skilled in the art will recognize that these regions can have many more items that can be found in a real-life universe as well as things that do not presently exist in real life.

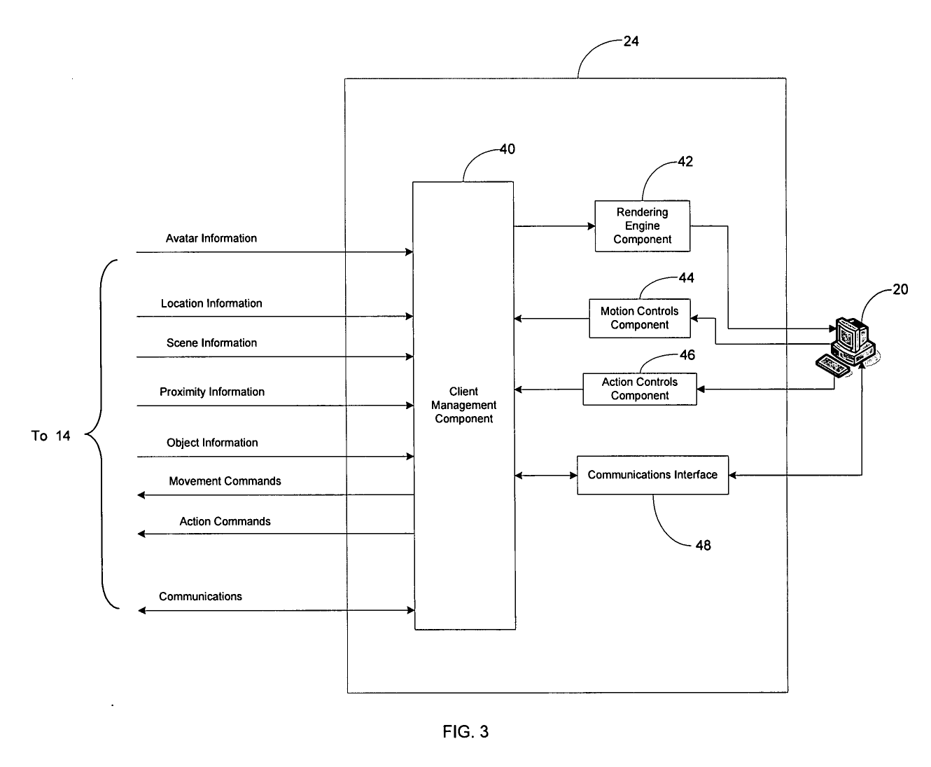

FIG. 3 shows a more detailed view of the virtual universe client 24 shown in FIG. 1. The virtual universe client 24, which enables users to interact with the virtual universe 12, comprises a client management component 40, which manages actions, movements and communications made by a user through computer 20, and information received from the virtual universe through the server array 14. A rendering engine component 42 enables the user of the computer 20 to visualize his or her avatar within the surroundings of the particular region of the virtual universe 12 that it is presently located. A motion controls component 44 enables the user to make movements through the virtual universe. In one embodiment, movements through the virtual universe can include for example, gestures, postures, walking, running, driving, flying, etc. An action controls component 46 enables the user to perform actions in the virtual universe such as buying items for his or her avatar or even for their real-life selves, building homes, planting gardens, etc., as well as changing the appearance of their avatar. These actions are only illustrative of some possible actions that a user can perform in the virtual universe and are not limiting of the many possible actions that can be performed. A communications interface 48 enables a user to communicate with other users of the virtual universe 12 through modalities such as chatting, instant messaging, gesturing, talking and electronic mail (e-mail).

FIG. 3 shows the various types of information received by the client management component 40 from the virtual universe through the server array 14. In particular, the client management component 40 receives avatar information about the avatars that are in proximity to the user's avatar. In addition, the client management component 40 receives location information about the area that the user's avatar is near (e.g., what region or island he or she is in) as well as scene information (e.g., what the avatar sees). The client management component 40 also receives proximity information which contains information on what the user's avatar is near and object information which is information that can be obtained by one's senses (e.g., touch, taste, smell, etc.,) and what actions are possible for nearby objects (e.g., postures, movements, etc.). FIG. 3 also shows the movement commands and action commands that are generated by the user are sent to the server array via the client management component 40, as well as the communications that can be sent to the users of other avatars within the virtual universe.

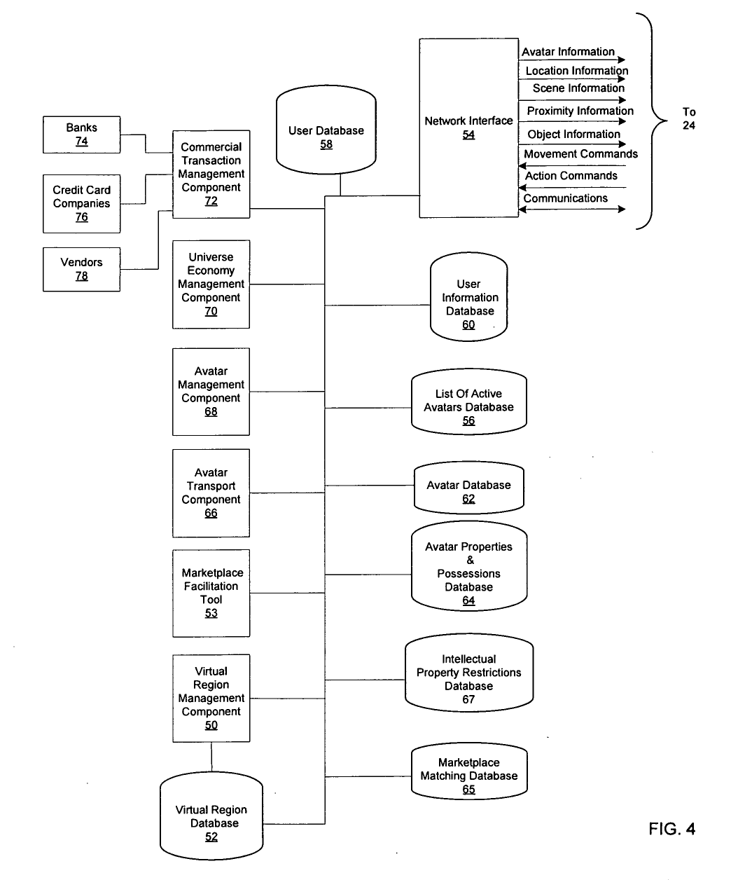

FIG. 4 shows a more detailed view of some of the functionalities provided by the server array 14 shown in FIG. 1. In particular, FIG. 4 shows a virtual region management component 50 that manages a virtual region within the virtual universe. In particular, the virtual region management component 50 manages what happens in a particular region such as the type of landscape in that region, the amount of homes, commercial zones, boutiques, streets, parks, restaurants, etc.

A virtual region database 52 stores information on all of the specifics in the virtual region 18 that the virtual region management component 50 is managing. In one embodiment, for very large virtual universes, one server 16 may be responsible for managing one particular virtual region 18 within the universe. In other embodiments, it is possible that one server 16 may be responsible for handling one particular island within the virtual region 18.

A marketplace facilitation tool 53 facilitates the exchange of items to avatars within the virtual universe 12. The marketplace provided by the marketplace facilitation tool 53 to avatars of the virtual universe 12 can be in the form of bartering, auctioning, trading, or selling items directly. In addition, the marketplace facilitation tool 53 has the capability to match avatars wishing to exchange or give up items to those avatars who wish to have specific items. The marketplace facilitation tool 53 also has the capability to specify, monitor and enforce intellectual property restrictions associated with the exchanged items. Below is a more detailed discussion of the marketplace facilitation tool 53 and how it performs some of the above-mentioned functions.

FIG. 4 shows a network interface 54 that enables the server array 14 to interact with the virtual universe client 24 residing on computer 20. In particular, the network interface 54 communicates avatar, location, scene, proximity and object information to the user through the virtual universe client 24 and receives movement and action commands as well as communications from the user via the universe client.

As shown in FIG. 4, there are several different databases for storing information. In particular, database 56 contains a list of all the avatars that are online in the virtual universe 12. Databases 58 and 60 contain information on the actual human users of the virtual universe 12. In one embodiment, database 58 contains general information on the users such as names, addresses, interests, ages, etc., while database 60 contains more private information on the users such as email addresses, billing information (e.g., credit card information) for taking part in transactions. Databases 62 and 64 contain information on the avatars of the users that reside in the virtual universe 12. In one embodiment, database 62 contains information such as all of the avatars that a user may have, the profile of each avatar, avatar characteristics (e.g., appearance, voice and movement features) while database 64 contains an inventory listing properties and possessions that each avatar owns such as hair pieces, jewelry, houses, cars, sporting equipment, appearance, attire, etc.

A marketplace matching database 65 contains functional capability requirements for a plurality of items that are configured for use in the virtual universe. For example, each script sold by a vendor or a selling avatar may have specific hardware requirements for a client system to run and use the script within the virtual universe 12. The marketplace matching database 65 keeps track of these requirements as well as other data such as parameters that characterize avatars and the landscape or virtual regions that avatars typically congregate in while on-line in the virtual universe 12. For example, in one embodiment, the marketplace matching database 65 may contain information on documents offered by an institute of higher learning or a selling avatar that may have minimum education or current enrollment requirements or recommendations, such as may be indicated in a user's profile, provided via a questionnaire, or otherwise determined.

An intellectual property restrictions database 67 contains a plurality of intellectual property restrictions that have been specified for the items created and exchanged within the virtual universe 12. These restrictions can be listed in the intellectual property restrictions database 67 in many forms. For example, the intellectual property restrictions database 67 can store the whole agreement documenting the restrictions or just the salient items like owner, term of usage, fee payment, type of usage, etc. In addition to the information listed above, the intellectual property restrictions database 67 can store data such as user attribute requirements, such as citizenship, age, etc. For example, legal requirements imposed by a government may preclude citizens under its jurisdiction from eligibility in certain types of intellectual property restrictions, especially when engaging in transactions with avatars representative of other countries.

Those skilled in the art will recognize that databases 58-67 may contain additional information if desired. Although the above information is shown in FIG. 4 as being stored in databases, those skilled in the art will recognize that other means of storing information can be utilized.

An avatar transport component 66 enables users to transport, which as mentioned above, allows avatars to transport through space from one point to another point, instantaneously. As a result, an avatar could for example travel from a business region to an entertainment region to experience a concert. Moving from one point or virtual region to another point could ultimately affect the inventory items that an avatar could use in a particular location. For example, if the avatar was leaving work from the business district with some proprietary information then the transformation tool of this invention could transform the proprietary information to a newspaper. In this example, well-known encryption/decryption techniques can be used in the transformation of documentation.

An avatar management component 68 keeps track of what online avatars are doing while in the virtual universe. For example, the avatar management component 68 can track where the avatar presently is in the virtual universe, what activities it is performing or has recently performed. An illustrative but non-exhaustive list of activities can include shopping, eating, talking, recreating, etc.

Because a typical virtual universe has a vibrant economy, the server array 14 has functionalities that are configured to manage the economy. In particular, a universe economy management component 70 manages transactions that occur within the virtual universe between avatars. In one embodiment, the virtual universe 12 will have their own currency that users pay for with real-life money. The users can then take part in commercial transactions for their avatars through the universe economy management component 70. For example, an avatar might want to pay for a service for using the item exchange marketplace tool 53. For example, in one instance, the buying avatar would pay a transaction fee for purchasing an item through the exchange. In another embodiment, the selling avatar may pay fees for the sale of an item and/or the monitoring of any intellectual property rights restrictions associated with the sold item. In this case, a commercial transaction management component 72 allows the user to participate in the transaction. In order to fulfill any of these transactions and others similarly related, the commercial transaction management component 72 interacts with banks 74, credit card companies 76 and vendors 78.

Although not expressly shown in FIG. 4, all of the components shown in the figure are configured to interact with each other. The components that are shown as being interconnected are illustrated in that manner to convey the close interactions that exist between these components such as the banks 74, credit card companies 76, and vendors with the commercial transaction management component 72.

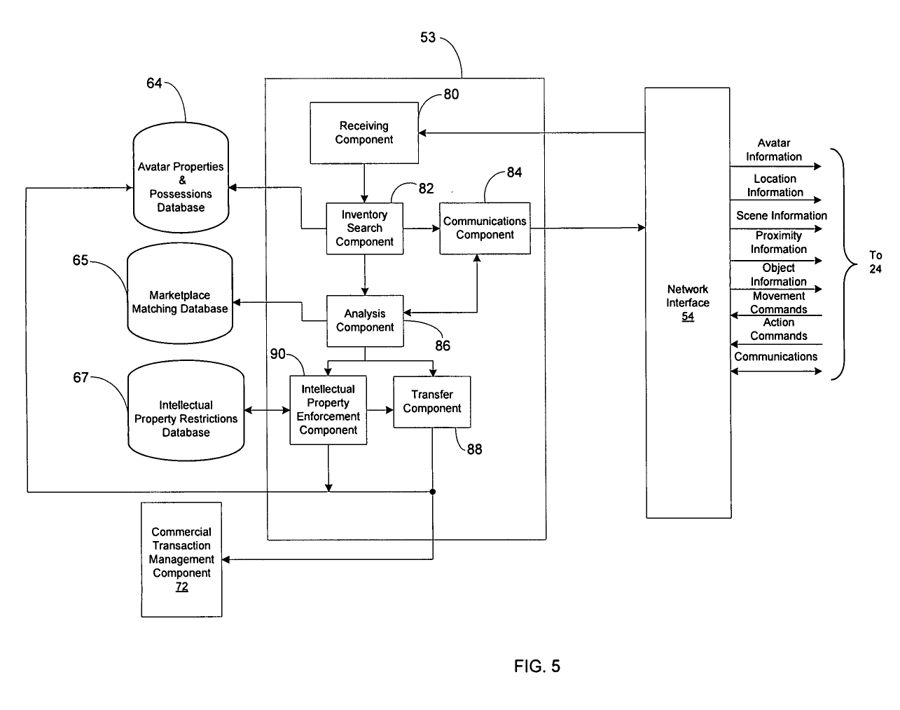

FIG. 5 is a schematic block diagram that shows more details of the marketplace facilitation tool 53 according to one embodiment. Although not shown in FIG. 5, the marketplace facilitation tool 53 may reside in the server array 14 and communicate directly to the virtual universe 12 and its residents via the virtual universe client 24. In another embodiment, the marketplace facilitation tool 53 may reside on a separate computer remote of the server array 14 and the virtual universe client 24, but in direct communication with these systems. Still in another embodiment, parts of the marketplace facilitation tool 53 may reside on both the server array 14 and the virtual universe client 24.

The marketplace facilitation tool 53 as shown in the embodiment of FIG. 5 comprises a receiving component 80 configured to receive a request for an item from an avatar within the virtual universe. There are several ways in which an avatar can make a request for an item from other avatars within the virtual universe 12. In one embodiment, the requesting avatar can make the request by using a mouse or a keyboard. In a second embodiment, an avatar may place a low-resolution simulacrum of an item in his or her inventory of items to signal that the user wants the actual virtual universe item. For instance, an avatar may place a low-resolution version of a car of a particular model in his or her inventory. This item will contain information on the model of the virtual universe car. In a third embodiment, the receiving component 80 can initiate the exchange without an express trigger from a requesting avatar. In this embodiment, the receiving component 80 may be configured to periodically search a wants and needs database that lists the wants and needs of items for avatars residing in the virtual universe 12. Instead of searching a specialized database, the receiving component 80 can be configured to search for these items in each avatar's inventory, an auction and/or a specialized web site that contains such information.

An inventory search component 82 is configured to search the avatar properties and possessions database 64 for other avatars within the virtual universe 12 that may possess the requested item. In particular, the inventory search component 82 can search the avatar properties and possessions database 64 for matches with the requested item by using a variety of searching techniques. In one embodiment, the inventory search component 82 uses a text search to search for text that describes the requested item that is similar to the text entered by requesting avatar. Using known text comparison techniques, the inventory search component 82 can find the closest matching items that have similar textual descriptions. In another embodiment, if the item that an avatar seeks to obtain is graphical in nature, then the inventory search component 82 uses known image comparison techniques to find the closest matching items that have similar graphic images. One type of image comparison technique that can be used is a Query By Image Content (QBIC™) system developed by International Business Machines Corporation.

The amount of similar items that the inventory search component 82 will retrieve will depend on how unique the item is. In one embodiment, the inventory search component 82 retrieves the 30 closest objects to the content that an avatar seeks to obtain, but the number actually returned could be lower depending on the amount of similar objects found. Those skilled in the art will recognize that the amount of items retrieved in a search can vary and that number listed above is only an example and not meant to be limiting.

In another embodiment, the inventory search component 82 is not limited to searching avatar properties and possessions database 64. It is possible that such items may be stored elsewhere in the virtual universe in other repositories or even outside the virtual universe 12 and into other virtual universes as well as other databases that may exist in the real-world. For example, the inventory search component 82 can search in other virtual universes that have databases or repositories storing digital content that users have noted as being licensable to other avatars. It is also possible that the inventory search component 82 could search databases that exist in the real world.

A communications component 84 is configured to notify any avatars that have been determined to have possession of the requested item that the item is desired by the requesting avatar. In one embodiment, the communications component 84 notifies an inventory receiver element (and their owner-residents) that an avatar has a desire for a particular item that they happen to possess. For example, a message could contain the following information: “Resident ID, item requested, date when the inventory item is needed, price offered, object to be bartered.” A second avatar's inventory receiver element would receive this message. Instead of sending notifications to avatars that possess the requested object, it is possible that the communications component 84 can send a message to all avatars within the virtual universe. In these embodiments, the communications component 84 can send these notifications by an instant message, email, audio message, or the like.

An analysis component 86 receives the results retrieved from the inventory search component 82. In addition to receiving the results, the analysis component 86 is configured to ascertain whether the avatar requesting the item has the functional capability to receive the item from any avatar determined to have possession of the requested item. In particular, if the item is found, the analysis component 86 performs a functional prerequisite/co-requisite comparison to determine whether the requesting avatar has the capabilities to receive the object. For example, avatars with different technologies may be capable of receiving and implementing only a certain set of functions. For these avatars, it would be inappropriate or ineffective to acquire certain software. For instance, one avatar may wish to have a special gesture, however that avatar may not have the proper prerequisite software. Alternatively, one avatar may wish to acquire an item that is not allowed on a particular piece of virtual land. Thus, the analysis component 86 uses a matching module to access the marketplace matching database 65 to determine whether the requesting avatar has the functional capabilities to receive the item.

As shown in FIG. 5, the analysis component 86 is further configured to receive communications from the communications component 84. In particular, the communications component 84 receives notifications that can come from the requesting avatar and/or avatars that have items that match what is desired by the requesting avatar. For example, the requesting avatar can notify the analysis component 84 of its intent to purchase the item from an avatar and the analysis component 84 can also receive notifications from avatars within the virtual universe 12 with regard to their intention to sell the item to the requesting avatar.

A transfer component 88 is configured to establish a transfer of the item between the requesting avatar and an avatar that is in possession of an item, assuming that there has been a manifestation of an assent between the parties to transfer the item. In one embodiment, the transfer component 88 transfers the item from the inventory of the avatar selling the object to the inventory of the requesting avatar. Payment for this transaction is implemented via the commercial transaction management component 72. If barter is the form of payment for the item, then the requesting avatar will provide the barter to the selling avatar or the transfer component 88 can transfer that barter to the selling avatar.

In the case of an auction or in a case of the first resident's attempt to achieve the “best price”, multiple residents may be invited to provide a requested item and in these kinds of cases, the first resident who desires the item may be informed of the offering price of the various desired items by other residents. The first resident may then select the lowest price. In an auction scenario, several of the above-noted steps may be repeated until a deal is reached. The transfer component 88 can then transfer the item to the “winning” avatar and the commercial transaction management component 72 can be used to complete the transaction.

An intellectual property enforcement component 90 operates concurrently with the transfer component 88. In particular, the intellectual property enforcement component 90 is configured to specify, monitor and enforce any intellectual property rights restrictions that are associated with the item transferred by the transfer component 88. In essence, the intellectual property enforcement component 90 ensures that intellectual property rights such as license restrictions associated with an exchanged items is respected. For example, the intellectual property enforcement component 90 can determine that it is okay if a first avatar gets a special model of a virtual universe car so long as it is removed from a second avatar's inventory and only one instantiation exists. In one embodiment, the intellectual property enforcement component 90 uses the intellectual property restrictions database 67 to specify restrictions, monitor usage for conformance with these restrictions and enforce if these restrictions are not followed. In one embodiment, the intellectual property enforcement component 90 scans the item to be exchanged, reads license information associated with the item from the database 67, and does not permit the exchange until the license condition is met. For example, when an item is about to be transferred, the second avatar may receive a message that says, “Your inventory item will be deleted to comply with license restrictions. OK?”

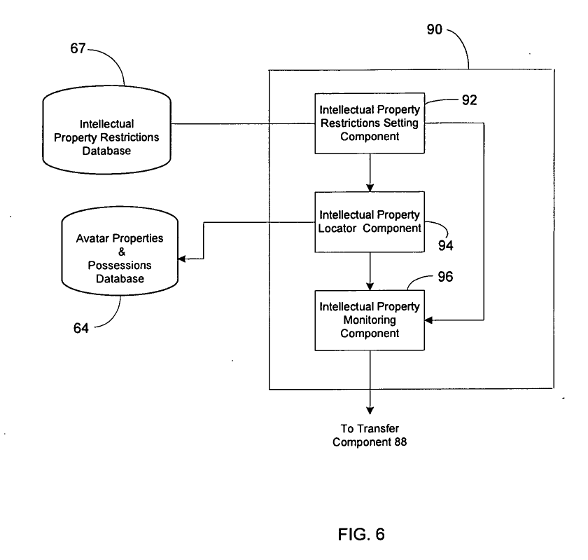

FIG. 6 shows a more detailed view of the intellectual property enforcement component 90. As shown in FIG. 6, the intellectual property enforcement component 90 comprises an intellectual property restrictions setting component 92 that is configured to specify the intellectual property restrictions (e.g., license restrictions) so that these restrictions are appended with the transfer so that they have to be agreed to as a condition for receiving the item in the exchange from the transfer component 88. In one embodiment, the intellectual property restrictions setting component 92 uses the intellectual property restrictions database 67 to ensure that the proper restrictions are specified to the exchanged item. Those skilled in the art will recognize that owners of licensable items always have the option to override the restrictions set forth in the intellectual property restrictions database 67 and provide a different set of restrictions.

After the item has been transferred, an intellectual property locator component 94 is configured to locate usage of the transferred item within the virtual universe 12. In particular, the intellectual property locator component 94 is also configured to determine what virtual regions the transferred item is being used. In addition to or in place thereof, the intellectual property locator component 94 is also configured to search the avatar inventories stored in the avatar properties and possession database 64 to determine how the transferred objects are being used by the avatars within the virtual universe 12.

The intellectual property locator component 94 conveys this information onto the intellectual property monitoring component 96 which decides whether the usage is in conformance with the restrictions specified by the intellectual property restrictions setting component 92. In one embodiment, the intellectual property monitoring component 96 can notify the owner and/or the user of the licensed item that there is a violation of the terms specified in the intellectual property restrictions. In one embodiment, the intellectual property monitoring component 96 can be configured to resolve the unauthorized use (e.g., disable use, ensure usage does conform to restrictions) or leave the matter to the owner and user of the intellectual property to resolve the outstanding matter. Those skilled in the art will recognize that owners of licensable items and those who have already received transferred objects always have the option to override the restrictions set forth in the intellectual property restrictions database 67 and provide a different set of restrictions at any time, either with or without mutual agreement, subject to any prior restrictions, virtual universe policies, or legal requirements.

Although the marketplace facilitation tool 53 in FIG. 5 is directed to the exchange of items in a marketplace environment per se, those skilled in the art will recognize that the tool can be used to facilitate transfers in other scenarios. For example, if an avatar sees an item in the virtual universe (whether owned by another avatar or offered for sale by a third party such as a store) that has intellectual property restrictions associated therewith, then the marketplace facilitation tool 53 can be used by the avatar to make an offer for the item and transfer the item after there has been a manifestation of an assent to transfer the item between parties. In this embodiment, the marketplace facilitation tool 53 would comprise the receiving component 80, the transfer component 88 and the intellectual property enforcement component 90.

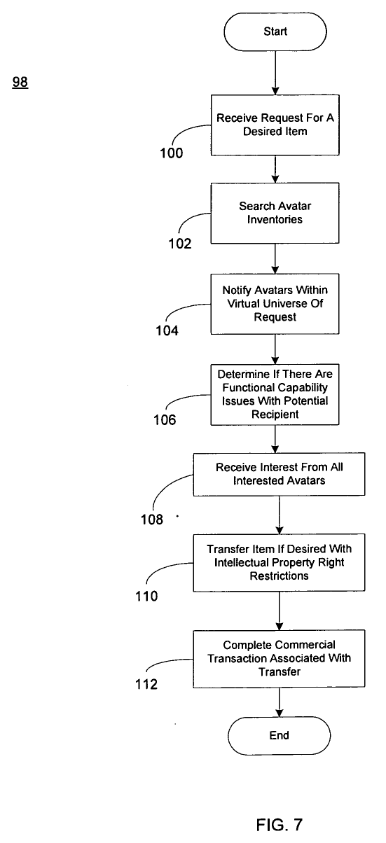

FIG. 7 shows a flow chart describing the operation 98 of the marketplace facilitation tool 53 for the embodiment shown in FIG. 5. The operation begins with the receiving component 80 receiving a request for an item from an avatar within the virtual universe at 100. As mentioned above, the request can be triggered specifically by an avatar or the receiving component 80 can be configured to periodically initiate a search of a wants and needs database and/or a specialized web site that contains the wants and needs of avatars within the virtual universe 12. Each scenario is considered an act of receiving a request for an item.

At 102, the inventory search component 82 begins searching the avatar properties and possessions database 64 for other avatars within the virtual universe 12 that may possess the requested item. The communications component 84 notifies avatars within the virtual universe 12 at 104 of the requested item. In one embodiment, the communications component 84 notifies avatars that have been determined to have possession of the requested item. As mentioned above, the communications component 84 can send these notifications by an instant message, email, audio message, or the like.

The analysis component 86 ascertains at 106 whether the avatar requesting the item has the functional capability to receive the item from any avatar determined to have possession of the requested item. In particular, if the item is found, the analysis component 86 performs a functional prerequisite/co-requisite comparison to determine whether the requesting avatar has the capabilities to receive the object.

At 108, the communications component 84 receives notifications from the requesting avatar and/or avatars that have items that match what is desired by the requesting avatar. In particular, the communications component 84 receives notification that indicates whether requesting avatar and the avatars that have the item want to go forward with the transaction.

The transfer component 88 transfers the item between the requesting avatar and an avatar that desires to transfer the item at 110 along with any specified intellectual property restrictions. In one embodiment, the transfer component 88 transfers the item from the inventory of the avatar selling the object to the inventory of the requesting avatar. Payment for this transaction is implemented via the commercial transaction management component 72 at 112.

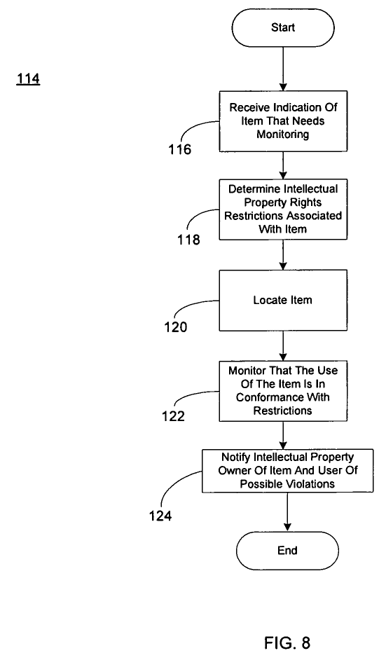

FIG. 8 shows a flow chart describing the operation 114 of monitoring usage of an exchanged item for conformance with intellectual property rights restrictions specified to the item. The flow chart of FIG. 8 begins at 116 where the intellectual property enforcement component 90 receives an indication that a particular item that has been the subject of an exchange needs to be monitored. In response to receiving this indication for monitoring, the intellectual property restrictions setting component 92 searches the intellectual property restrictions database 67 at 118 to ascertain the intellectual property restrictions that have been specified for the item of interest.

The intellectual property locator component 94 locates the item within the virtual universe 12 at 120. As mentioned above, the intellectual property locator component 94 can also determine what virtual regions the transferred item is being used and how it is being used. In one embodiment, the intellectual property locator component 94 can ascertain this information by searching the avatar inventories stored in the avatar properties and possession database 64.

The intellectual property locator component 94 conveys this information onto the intellectual property monitoring component 96 which monitors the usage of the interested item at 122. In particular, the intellectual property monitoring component 96 decides whether the usage is in conformance with the restrictions specified by the intellectual property restrictions setting component 92.

At 124, the intellectual property monitoring component 96 notifies the owner and/or the user of the licensed item that there is a violation of the terms specified in the intellectual property restrictions. As mentioned above, the intellectual property monitoring component 96 can be configured to resolve the unauthorized use (e.g., disable use, ensure usage does conform to restrictions) or leave the matter to the owner and user of the intellectual property to resolve.

The foregoing flow charts of FIGS. 7 and 8 show some of the processing functions associated with using the marketplace facilitation tool 53 and the intellectual property enforcement component 90 to facilitate the exchange of licensed items within the virtual universe 12. In this regard, each block in the tool represents a component and a process act associated with performing these functions. It should also be noted that in some alternative implementations, the acts noted in the blocks may occur out of the order noted in the figure or, for example, may in fact be executed substantially concurrently or in the reverse order, depending upon the act involved. Also, one of ordinary skill in the art will recognize that there may be additional or less blocks that describe these processing acts. For example, in the embodiment where the marketplace facilitation tool 53 can be used to facilitate transfers directly between avatars or third parties and avatars (i.e., no market matching scenario), the processing blocks of FIG. 7 would have different blocks to reflect this direct exchange of intellectual property restricted items in a non-market matching environment.

In one embodiment, the marketplace facilitation tool 53 could charge fees to the buyers and sellers of the item exchanged. Alternatively, the marketplace facilitation tool 53 could be run as a service where users pay a subscription and/or fee to use the tool. Likewise, usage of the intellectual property enforcement component 90 could be used in addition to or separate from the marketplace facilitation tool 53. Those skilled in the art will realize that there are a variety of payments scenarios that could be put into place for using the marketplace facilitation tool 53 and the intellectual property enforcement component 90.

In another embodiment of this invention, the marketplace facilitation tool 53 and the intellectual property enforcement component 90 could be offered to the provider of a virtual universe or a third party service provider could offer these tools as a service by performing the functionalities described herein on a subscription and/or fee basis. In this case, the provider of the virtual universe or the third party service provider can create, deploy, maintain, support, etc., the marketplace facilitation tool 53 and the intellectual property enforcement component 90 that perform the processes described in the invention. In return, the virtual universe or the third party service provider can receive payment from the virtual universe residents via a universe economy management component and/or a commercial transaction management component.

In still another embodiment, the methodologies disclosed herein can be used within a computer system to facilitate exchange and protection of items created by users of a virtual universe. In this case, the marketplace facilitation tool 53 and the intellectual property enforcement component 90 can be provided and one or more systems for performing the processes described in the invention can be obtained and deployed to a computer infrastructure. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

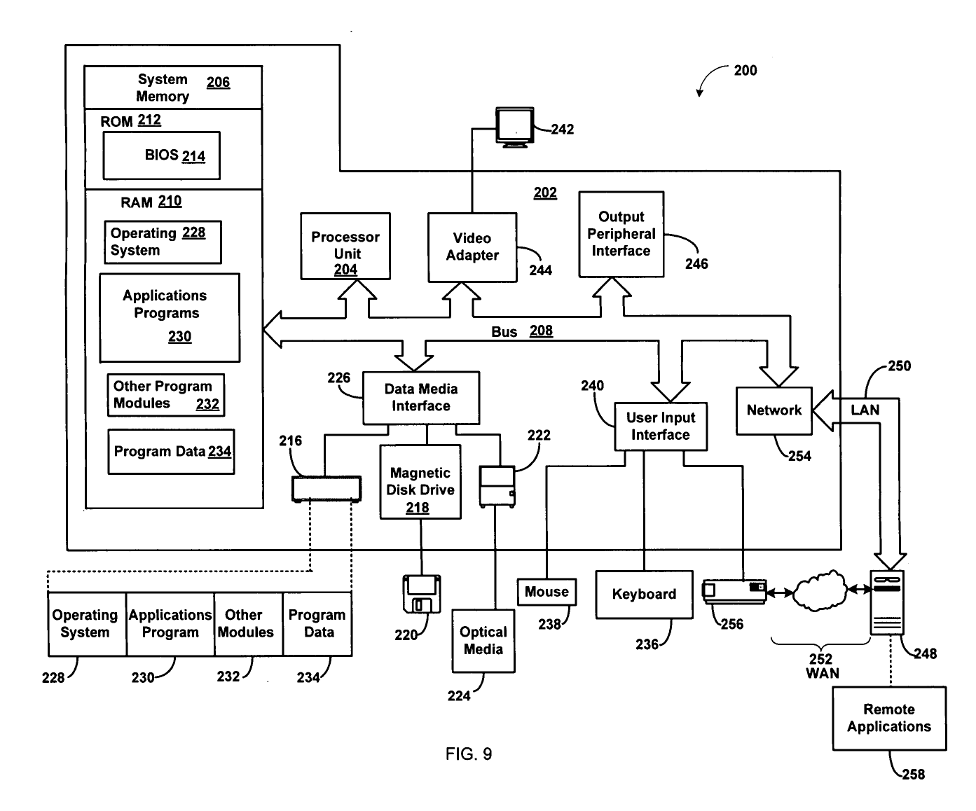

FIG. 9 shows a schematic of an exemplary computing environment 200 in which elements of the networking environment shown in FIG. 1 may operate. The exemplary computing environment 200 is only one example of a suitable computing environment and is not intended to suggest any limitation as to the scope of use or functionality of the approach described herein. Neither should the computing environment 200 be interpreted as having any dependency or requirement relating to any one or combination of components illustrated in FIG. 9.

In the computing environment 200 there is a computer 202 which is operational with numerous other general purpose or special purpose computing system environments or configurations. Examples of well known computing systems, environments, and/or configurations that may be suitable for use with an exemplary computer 202 include, but are not limited to, personal computers (PC), server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary computer 202 may be described in the general context of computer-executable instructions, such as program modules, being executed by a computer. Generally, program modules include routines, programs, objects, components, logic, data structures, and so on, that performs particular tasks or implements particular abstract data types. The exemplary computer 202 may be practiced in distributed computing environments where tasks are performed by remote processing devices that are linked through a communications network. In a distributed computing environment, program modules may be located in both local and remote computer storage media including memory storage devices.

As shown in FIG. 9, the computer 202 in the computing environment 200 is shown in the form of a general-purpose computing device. The components of computer 202 may include, but are not limited to, one or more processors or processing units 204, a system memory 206, and a bus 208 that couples various system components including the system memory 206 to the processor 204.

Bus 208 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 202 typically includes a variety of computer readable media. Such media may be any available media that is accessible by computer 202, and it includes both volatile and non-volatile media, removable and non-removable media.

In FIG. 9, the system memory 206 includes computer readable media in the form of volatile memory, such as random access memory (RAM) 210, and/or non-volatile memory, such as ROM 212. A BIOS 214 containing the basic routines that help to transfer information between elements within computer 202, such as during start-up, is stored in ROM 212. RAM 210 typically contains data and/or program modules that are immediately accessible to and/or presently operated on by processor 204.

Computer 202 may further include other removable/non-removable, volatile/non-volatile computer storage media. By way of example only, FIG. 9 illustrates a hard disk drive 216 for reading from and writing to a non-removable, non-volatile magnetic media (not shown and typically called a “hard drive”), a magnetic disk drive 218 for reading from and writing to a removable, non-volatile magnetic disk 220 (e.g., a “floppy disk”), and an optical disk drive 222 for reading from or writing to a removable, non-volatile optical disk 224 such as a CD-ROM, DVD-ROM or other optical media. The hard disk drive 216, magnetic disk drive 218, and optical disk drive 222 are each connected to bus 208 by one or more data media interfaces 226.

The drives and their associated computer-readable media provide nonvolatile storage of computer readable instructions, data structures, program modules, and other data for computer 202. Although the exemplary environment described herein employs a hard disk 216, a removable magnetic disk 218 and a removable optical disk 222, it should be appreciated by those skilled in the art that other types of computer readable media which can store data that is accessible by a computer, such as magnetic cassettes, flash memory cards, digital video disks, RAMs, ROM, and the like, may also be used in the exemplary operating environment.

A number of program modules may be stored on the hard disk 216, magnetic disk 220, optical disk 222, ROM 212, or RAM 210, including, by way of example, and not limitation, an operating system 228, one or more application programs 230, other program modules 232, and program data 234. Each of the operating system 228, one or more application programs 230, other program modules 232, and program data 234 or some combination thereof, may include an implementation of the networking environment 10 of FIG. 1 including the server array 14, the virtual universe client 24, the marketplace facilitation tool 53 and the intellectual property enforcement component 90. In one embodiment, the one or more application programs 230 include components of the marketplace facilitation tool 53 such as the receiving component 80, inventory search component 82, communications component 84, analysis component 86, transfer component 88 and intellectual property enforcement component 90 (i.e., the intellectual property restrictions settings component 92, intellectual property locator component 94, and intellectual property monitoring component 96).

A user may enter commands and information into computer 202 through optional input devices such as a keyboard 236 and a pointing device 238 (such as a “mouse”). Other input devices (not shown) may include a microphone, joystick, game pad, satellite dish, serial port, scanner, camera, or the like. These and other input devices are connected to the processor unit 204 through a user input interface 240 that is coupled to bus 208, but may be connected by other interface and bus structures, such as a parallel port, game port, or a universal serial bus (USB).

An optional monitor 242 or other type of display device is also connected to bus 208 via an interface, such as a video adapter 244. In addition to the monitor, personal computers typically include other peripheral output devices (not shown), such as speakers and printers, which may be connected through output peripheral interface 246.

Computer 202 may operate in a networked environment using logical connections to one or more remote computers, such as a remote server/computer 248. Remote computer 248 may include many or all of the elements and features described herein relative to computer 202.

Logical connections shown in FIG. 9 are a local area network (LAN) 250 and a general wide area network (WAN) 252. Such networking environments are commonplace in offices, enterprise-wide computer networks, intranets, and the Internet. When used in a LAN networking environment, the computer 202 is connected to LAN 250 via network interface or adapter 254. When used in a WAN networking environment, the computer typically includes a modem 256 or other means for establishing communications over the WAN 252. The modem, which may be internal or external, may be connected to the system bus 208 via the user input interface 240 or other appropriate mechanism.

In a networked environment, program modules depicted relative to the personal computer 202, or portions thereof, may be stored in a remote memory storage device. By way of example, and not limitation, FIG. 9 illustrates remote application programs 258 as residing on a memory device of remote computer 248. It will be appreciated that the network connections shown and described are exemplary and other means of establishing a communications link between the computers may be used.

An implementation of an exemplary computer 202 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable media containing computer instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for redistributing licensed items in a virtual universe. While the invention has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the invention.

What is claimed is:

1. A method for facilitating an exchange of items in a virtual universe, comprising:
receiving a request for an item within the virtual universe;
establishing a transfer of the item between at least one provider and an avatar requesting the item after there has been a manifestation of an assent to transfer the item; and
specifying any intellectual property rights restrictions with the item in the transfer between the at least one provider and the avatar requesting the item.

2. The method according to claim 1, wherein the specifying of intellectual property rights restrictions comprises searching an intellectual property restrictions database containing restrictions associated with a plurality of items that are configured for use in the virtual universe.

3. The method according to claim 1, further comprising monitoring usage of the item for conformance with any specified intellectual property rights restrictions after transfer between the least one provider and the avatar requesting the item.

4. The method according to claim 1, further comprising assessing a transaction fee for facilitating the transfer of the item between the least one provider and the avatar requesting the item.

5. The method according to claim 4, wherein the assessing of the transaction fee comprises assessing a fee against the requesting avatar and/or the at least one provider.

6. A method for facilitating a marketplace to exchange items in a virtual universe, comprising:
receiving a request for an item within the virtual universe;
matching at least one provider of that item with an avatar requesting the item;
establishing a transfer of the item between the at least one provider and the avatar requesting the item after there has been a manifestation of an assent to transfer the item; and
specifying any intellectual property rights restrictions with the item in the transfer between the at least one provider and the avatar requesting the item.

7. The method according to claim 6, wherein the matching of the at least one provider of that item and the avatar requesting the item comprises searching an avatar properties and possessions database containing inventories of items possessed by avatars within the virtual universe;

8. The method according to claim 7, further comprising determining whether the item requested by the avatar is in the inventory of any of the avatars contained in the avatar properties and possessions database.

9. The method according to claim 8, further comprising notifying any avatars that have been determined to have possession of the item that the item is desired by the requesting avatar.

10. The method according to claim 6, wherein the matching of the at least one provider of that item and the avatar requesting the item comprises ascertaining whether the avatar requesting the item has the functional capability to receive the item.

11. The method according to claim 10, wherein the ascertaining of functional capability comprises searching a marketplace matching database containing functional capability requirements for a plurality of items that are configured for use in the virtual universe.

12. The method according to claim 6, wherein the specifying of intellectual property rights restrictions comprises searching an intellectual property restrictions database containing restrictions associated with a plurality of items that are configured for use in the virtual universe.

13. The method according to claim 6, further comprising monitoring usage of the item for conformance with any specified intellectual property rights restrictions after transfer between the least one provider and the avatar requesting the item.

14. The method according to claim 6, further comprising assessing a transaction fee for facilitating the transfer of the item between the least one provider and the avatar requesting the item.

15. A computer system for facilitating a marketplace to exchange items in a virtual universe, comprising:
at least one processing unit;
memory operably associated with the at least one processing unit; and
a marketplace facilitation tool storable in memory and executable by the at least one processing unit, the tool comprising:
a database configured to store a plurality of information relating to the virtual universe;
a receiving component configured to receive a request for an item within the virtual universe;
an inventory search component configured to search the database for other avatars within the virtual universe that may possess the requested item;
a transfer component configured to establish a transfer of the item between at least one avatar determined to have possession of the requested item and an avatar requesting the item after there has been a manifestation of an assent to transfer the item; and
an intellectual property enforcement component configured to specify and enforce any intellectual property rights restrictions with the item to the transfer component for the transfer to the avatar requesting the item.

16. The tool according to claim 15, wherein the database comprises an avatar properties and possessions database containing inventories of items possessed by avatars within the virtual universe, a marketplace matching database containing functional capability requirements for a plurality of items that are configured for use in the virtual universe and an intellectual property restrictions database containing restrictions associated with a plurality of items that are configured for use in the virtual universe.

17. The tool according to claim 15, further comprising a communications component configured to notify any avatars that have been determined to have possession of the requested item that the item is desired by the requesting avatar.

18. The tool according to claim 15, further comprising an analysis component configured to ascertain whether the avatar requesting the item has the functional capability to receive the item from any avatar determined to have possession of the requested item.

19. The tool according to claim 15, wherein the intellectual property enforcement component comprises an intellectual property locator component configured to locate usage of the transferred item within the virtual universe.

20. The tool according to claim 19, wherein the intellectual property enforcement component comprises an intellectual property monitoring component configured to monitor usage of the item for conformance with any specified intellectual property rights restrictions after locating the item with the intellectual property locator component.

21. The tool according to claim 15, further comprising a commercial transaction management component configured to assess a transaction fee for facilitating the transfer of the requested item.

22. A computer-readable medium storing computer instructions, which when executed, enables a computer system to facilitate a marketplace to exchange items in a virtual universe, the computer instructions comprising:
receiving a request for an item within the virtual universe;
matching at least one provider of that item with an avatar requesting the item;
establishing a transfer of the item between the at least one provider and the avatar requesting the item after there has been a manifestation of an assent to transfer the item; and
specifying any intellectual property rights restrictions with the item in the transfer between the at least one provider and the avatar requesting the item.

23. The computer-readable medium according to claim 22, wherein the specifying of intellectual property rights restrictions comprises instructions for searching an intellectual property restrictions database containing restrictions associated with a plurality of items that are configured for use in the virtual universe.

24. The computer-readable medium according to claim 22, further comprising instructions for monitoring usage of the item for conformance with any specified intellectual property rights restrictions after transfer between the least one provider and the avatar requesting the item.

25. A method for deploying a marketplace facilitation tool for use in a computer system that facilitates an exchange of items in a virtual universe, comprising:
providing a computer infrastructure operable to:
receive a request for an item from an avatar within the virtual universe;
establish a transfer of the item between at least one provider and the avatar requesting the item after there has been a manifestation of an assent to transfer the item; and
specify any intellectual property rights restrictions with the item in the transfer between the at least one provider and the avatar requesting the item.
